(19) United States
(12) Patent Application Publication
(10) Pub. No.: US 2025/0190215 A1
(43) Pub. Date: Jun. 12, 2025

(54) PROCESSING-IN-MEMORY (PIM) DEVICE AND OPERATING METHOD OF PIM DEVICE

(71) Applicant: SAMSUNG ELECTRONICS CO., LTD., SUWON-SI (KR)

(72) Inventors: JINSEONG KIM, SUWON-SI (KR); JIHOON NAM, SUWON-SI (KR)

(21) Appl. No.: 18/969,749

(22) Filed: Dec. 5, 2024

(30) Foreign Application Priority Data
Dec. 6, 2023 (KR) 10-2023-0175728

(51) Int. Cl. G06F 9/30

(52) U.S. Cl. CPC G06F 9/3001; G06F 9/3013; G06F 9/30145

(57) ABSTRACT

A processing-in-memory (PIM) device includes processing elements (PEs), memory banks, control logic, and a command decoder. Each of the PEs includes a selection circuit configured to select a path from among a transmission path of memory data, a transmission path of PIM data for a multiply-accumulate (MAC) operation, and a transmission path of an instruction for an internal processor. The memory banks are configured to store data corresponding to the PEs. The control logic is configured to generate a selection signal configured to cause the selection circuit to select the path to a memory bank among the memory banks. The command decoder is configured to decode a memory command for the memory bank and the control logic.

### CROSS-REFERENCE TO RELATED APPLICATION

This patent application claims priority under 35 USC § 119 (a) to Korean Patent Application No. 10-2023-0175728 filed on Dec. 6, 2023, in the Korean Intellectual Property Office, the entire disclosure of which is incorporated by reference in its entirety herein.

### 1. TECHNICAL FIELD

One or more embodiments below are directed to a processing-in-memory (PIM) device and an operating method of the PIM device.

### 2. DISCUSSION OF RELATED ART

In a von Neumann architecture computer system, a memory device is separate in function from a processor that performs operation tasks. Accordingly, in a system that requires operations on a large amount of data such as a neural network, big data and Internet of Things (IoT), a bottleneck may frequently occur between the memory device and the processor. A processing-in memory device that combines a function of a memory function with a function of a processor that performs operation tasks may reduce this bottleneck.

### SUMMARY

According to an aspect, there is provided a processing-in-memory (PIM) device including processing elements (PEs), memory banks, a control logic, and a command decoder. Each of the PEs includes a selection circuit configured to select a path from among a transmission path of memory data, a transmission path of PIM data for a multiply-accumulate (MAC) operation, and a transmission path of an instruction for an internal processor. The memory banks are configured to store data corresponding to the PEs. The control logic is configured to generate a selection signal configured to cause the selection circuit to select the path to a memory bank among the memory banks. The command decoder is configured to decode a memory command for the memory bank and the control logic.

The selection circuit may be configured to determine the path through which data of an activated row is to be fetched from each of the memory banks according to the selection signal.

For each row of each of the memory banks, a storage area corresponding to the memory data, a storage area corresponding to the PIM data, and a storage area corresponding to the instruction for the internal processor may be partitioned off from each other.

The control logic may include a register configured to store row information of at least one of a PIM area for a PIM operation or a storage area of the memory data in each of the memory banks according to the memory command.

Each of the PEs may include at least one of the internal processor, a MAC operation circuit configured to perform the MAC operation, or an instruction memory configured to store the instruction for the internal processor.

The instruction memory may include a register configured to store at least one of the memory command or the instruction for the internal processor, for reuse of the memory command or decoding of the instruction for the internal processor.

Each of the memory banks may be configured to store a PIM binary including at least one of a set of instructions or a plurality of memory commands, which may be written by a host device and executed in the PIM device.

According to an aspect, there is provided a PIM device including PEs, memory banks, and a command decoder. The memory banks are configured to store data corresponding to the PEs. The command decoder is configured to decode a memory command for a memory bank among the memory banks. Each of the PEs includes a selection circuit and control logic. The selection circuit is configured to select a path from among a transmission path of memory data, a transmission path of PIM data for a multiply-accumulate (MAC) operation, and a transmission path of an instruction for an internal processor. The control logic is configured to generate a selection signal configured to cause the selection circuit to select the path to the memory bank.

The selection circuit may be configured to determine the path through which data of an activated row is to be fetched from the memory bank, in response to the selection signal.

For each row of each of the memory banks, a storage area corresponding to the memory data, a storage area corresponding to the PIM data, and a storage area corresponding to the instruction for the internal processor may be partitioned off from each other.

The control logic may include a register configured to store row information of at least one of a PIM area for a PIM operation or a storage area of the memory data in the memory bank, in response to the memory command.

Each of the PEs may include the internal processor, a MAC operation circuit configured to perform the MAC operation, or an instruction memory configured to store the instruction for the internal processor.

The instruction memory may include a register configured to store at least one of the memory command or the instruction for the internal processor, for reuse of the memory command or decoding of the instruction for the internal processor.

Each of the memory banks may be configured to store a PIM binary including at least one of a set of instructions or a plurality of memory commands, which may be written by a host device and executed in the PIM device.

According to an aspect, there is provided an operating method of a PIM device including receiving, by control logic of the PIM device, a memory command from a host device when the host device executes a host program; generating, by the control logic, a selection signal for a path to at least one PE according to a row address of the memory command; opening, by a selection circuit of the PIM device, the path among a transmission path of memory data, a transmission path of PIM data for a multiply-accumulate (MAC) operation, and a transmission path of an instruction for an internal processor to a memory bank among a plurality of memory banks according to the selection signal; and executing, by the control logic, the memory command by fetching data through the opened path.

The generating of the selection signal for the path to the at least one PE may include transmitting a data address of an operand for executing the memory command to a command decoder and transmitting, by the command decoder, the row address of the memory command corresponding to the data address of the operand to the control logic by parsing the memory command.

When the control logic is present outside the at least one PE, the opening of the path may include opening, by the selection circuit, the path in each of the memory banks according to the selection signal.

When the control logic is present in each of the at least one PE, the opening of the path may include opening, by the selection circuit, the path in the memory bank, in response to the selection signal.

For each row of the memory bank, a storage area corresponding to the memory data, a storage area corresponding to the PIM data, and a storage area corresponding to the instruction for the internal processor may be partitioned off from each other.

The operating method of a PIM device may further include: writing, by the host device, a PIM binary into the memory bank of the PIM device; and writing, by the host device, row information of the memory bank into the control logic of the PIM device.

According to an aspect, there is provided a processing-in-memory (PIM) device including a memory bank, an internal processor, a logic circuit and a selection circuit. The memory bank includes a first region for storing memory data, a second region for storing PIM data, and a third region storing an instruction. The logic circuit is configured to perform a multiply-accumulate (MAC) operation. The selection circuit connect one of i) the first region to a first path to enable a host device to access the memory data, ii) the second region to a second path to enable the logic circuit to perform the MAC operation on the PIM data, and iii) the third region to a third path to enable the internal processor to execute the instruction, in response to receipt of a selection signal. The PIM device may further include control logic that generates the selection signal in response to receipt of a read command or a write command.

### BRIEF DESCRIPTION OF THE DRAWINGS

These and/or other aspects and features of the inventive concept will become apparent and more readily appreciated from the following description of embodiments, taken in conjunction with the accompanying drawings of which:

FIG. 1 is a block diagram illustrating a memory system including a processing-in-memory (PIM) device, according to an embodiment;

FIG. 2 is a diagram illustrating a configuration of a PIM device according to an embodiment;

FIG. 3 is a diagram illustrating a configuration of a PIM device according to an embodiment;

FIG. 4 is a flowchart illustrating an operating method of a PIM device, according to an embodiment;

FIG. 5 is a flowchart illustrating an operating method of a PIM device, according to an embodiment;

FIG. 6 is a diagram illustrating an operating method of an instruction of a PIM device, according to an embodiment;

FIG. 7 is a diagram illustrating an operation between a host device and a PIM device, according to an embodiment;

FIG. 8 is a flowchart illustrating a method of selecting a data path, according to an embodiment;

FIG. 9A is a diagram illustrating a structure in which an element-wise operation and a general matrix-vector multiplication (GEMV) operation are repeated in a neural network;

FIG. 9B is a diagram illustrating results of an operation of instruction writing and an operation of instruction execution compared between a general PIM device and a PIM device according to an embodiment;

FIG. 10 is a diagram illustrating a method of resolving constraints due to limitations of instruction memory in a PIM device, according to an embodiment.

### DETAILED DESCRIPTION

The following description is provided as examples of certain embodiments of the inventive concept that may be implemented. However, the inventive concept is not limited to these embodiments since various alterations and modifications may be made to the examples. Thus, the embodiments are understood to include all changes, equivalents, and replacements within the technical scope of this description.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise.

Embodiments described below may be applied, for example, to a neural network, a processor, a smartphone, a mobile device, and the like that perform an artificial intelligence (AI) operation and/or high-performance computing (HPC) processing, but are not limited thereto.

Hereinafter, the embodiments are described in detail with reference to the accompanying drawings. When describing the embodiments with reference to the accompanying drawings, like reference numerals refer to like components and a repeated description related thereto is omitted.

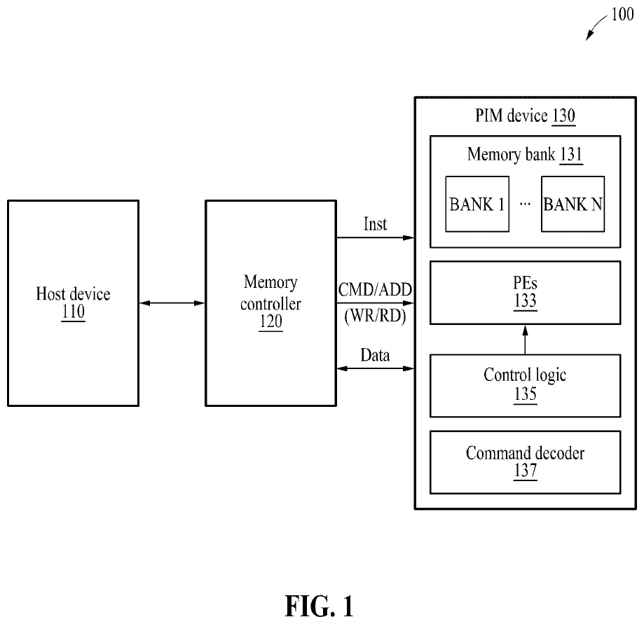

FIG. 1 is a block diagram illustrating a memory system including a processing-in-memory (PIM) device, according to an embodiment. Referring to FIG. 1, a memory system 100 according to an embodiment includes a memory controller 120 (e.g., a controller circuit) and a PIM device 130. The memory controller 120 may include, for example, a memory interface and may control a memory operation such as write and read operations by providing various signals to the PIM device 130 through the memory interface. For example, the memory controller 120 may access data Data of the PIM device 130 by providing a command CMD and an address ADD to the PIM device 130. The command CMD may be a write command WR requesting data recording or a read command RD requesting data reading, but is not limited thereto.

The memory controller 120 may access the PIM device 130 according to a request from a host device 110. The memory interface included in the memory controller 120 may provide an interface for interfacing with the PIM device 130. The memory controller 120 may communicate with the host device 110 using various protocols. For example, the memory controller 120 may communicate with the host device 110 using interface protocols such as peripheral component interconnect express (PCIe), advanced technology attachment (ATA), serial ATA (SATA), parallel ATA (PATA), or serial attached small computer system interface (SAS). In addition to the above, universal serial bus (USB), multi-media card (MMC), enhanced small disk interface (ESDI), integrated drive electronics (IDE), and other various interface protocols may be used for communication between the host device 110 and the memory controller 120.

The memory controller 120 may correspond to the host device 110. Alternatively, the memory controller 120 may correspond to a component provided in the host device 110.

The PIM device 130 may refer to a semiconductor including a processor (e.g., an internal processor) and a memory disposed on a single chip. In the PIM device 130, an instruction specific to the PIM device 130 for performing an operation may be performed. Instructions specific to the PIM device 130 may be referred to as a “PIM instruction”. The PIM instruction may be executed through a memory command transmitted by the memory controller 120. The memory command may be accessed through the host device 110 external to the PIM device 130.

The PIM device 130 may include, for example, a memory bank 131, processing elements (PEs) 133 (e.g., processors, microprocessors, logic circuits, etc.), a control logic 135 (e.g., a logic circuit), and a command decoder 137 (e.g., a decoder circuit). The memory bank 131 may include a multiple number of banks (e.g., BANK 1 to BANK N). Each of the banks (e.g., BANK 1 to BANK N) may include a multiple number of memory cells or a cell array including memory cells. Here, a bank may include memory cells, or a bank may include memory cells and one or more peripheral circuits. Hereinafter, for ease of description, the term “memory bank” may be simply referred to as a “bank.”

A memory bank to which data access is to be performed may be selected, and memory cells within the memory bank may be selected, by an address ADD transmitted from the memory controller 120. In addition, the command decoder 137 may perform a decoding operation on the command/address CMD/ADD transmitted from the memory controller 120 to generate a decoding result, and the control logic 135 may perform an internal control operation on the PIM device 130 so that a memory operation may be performed according to the decoding result.

The PIM device 130 may be, for example, dynamic random-access memory (DRAM), such as double data rate synchronous DRAM (DDR SDRAM), low power double data rate (LPDDR) SDRAM, graphics double data rate (GDDR) SDRAM, Rambus DRAM (RDRAM), and the like. However, embodiments are not limited thereto. The PIM device 130 may also be implemented as a non-volatile memory, such as flash memory, magnetic RAM (MRAM), ferroelectric RAM (FeRAM), phase change RAM (PRAM), resistive RAM (ReRAM), and the like.

In addition, the PIM device 130 may correspond to one semiconductor chip or may be a configuration corresponding to one channel in a memory device including multiple channels having an independent interface. Alternatively, the PIM device 130 may be a configuration corresponding to a memory module, and the memory module may include multiple memory chips.

Various types of processing operations may be performed in the PIM device 130. For example, one or more of the PEs 133 may perform one or more of the processing operations. For example, at least a portion of neural network operations related to AI may be performed in the PIM device 130. For example, the host device 110 may control the PIM device 130 through the memory controller 120 so that at least a portion of the neural network operations may be performed by the PIM device 130.

The memory controller 120 may transmit one or more instructions Inst to the PIM device 130 to perform a processing operation using data. The PIM device 130 may receive the instructions Inst and store the instructions Inst in the PIM device 130 (e.g., in an instruction memory). For example, the PIM device 130 may include the PEs 133 and an instruction memory for storing the instructions Inst. When the PIM device 130 receives a command/address CMD/ADD instructing operation processing transmitted from the memory controller 120, the PEs 133 of the PIM device 130 may perform an operation corresponding to the instruction Inst read by the instruction memory.

The memory controller 120 may transmit multiple instructions Inst to the PIM device 130 so that multiple processing operations may be sequentially performed. For example, the multiple instructions Inst may be loaded into the instruction memory (not shown) before actual processing of an operation is performed.

In addition, the memory controller 120 may, using commands related to general or normal memory operations, perform a control operation so that the PIM device 130 may perform operation processing. For example, a bit value of the address ADD provided by the memory controller 120 may be classified into multiple ranges. For example, the address ADD may instruct a memory operation or processing operation based on the bit value.

The PIM device 130 may selectively perform the memory operation or a processing operation in response to the command/address CMD/ADD from the memory controller 120. For example, the PIM device 130 may perform a processing operation in response to a data write command WR or a data read command RD transmitted from the memory controller 120.

The memory controller 120 may transmit an address ADD, in which instructions instructing a memory operation are stored, to the PIM device 130 together with the data write command WR or the data read command RD. In this case, the command decoder 137 of the PIM device 130 may perform a decoding operation on the received command/address CMD/ADD. When a value of the address ADD instructs a memory operation, the PIM device 130 may perform the memory operation of writing data Data in a location of the memory bank 131 indicated by the address ADD or of reading the data Data, according to the value of the decoded address ADD. In addition, when the value of the address ADD instructs a processing operation, the PIM device 130 may perform the processing operation according to a decoding result of the command/address CMD/ADD.

For example, the PEs 133 of the PIM device 130 may perform the processing operation using the data Data provided by the memory controller 120 or may perform the processing operation using the data Data read from the memory bank 131.

In addition, for example, the address ADD may include multiple bits. The address ADD may be related to a memory operation or a processing operation depending on the value of one or more bits of the address ADD at a specific location. In addition, at least a portion of the remaining bits excluding the bit(s) at the specific location of the address ADD may include information (e.g., a row address and a column address) indicating a location of the data Data. The PIM device 130 may read the data Data using information in the address ADD indicating the location of the memory bank 131 and perform the processing operation using the read data Data.

According to an embodiment, the operation processing by the PIM device 130 need not be performed only by the PIM device 130 independent of the host device 110 but may be performed in response to the command/address CMD/ADD from the memory controller 120, thereby preventing collision between a request for a memory operation from the memory controller 120 and a processing operation of the PIM device 130 itself. For example, a row of the memory bank 131 may be activated for a memory operation or a processing operation. In addition, the memory controller 120 may determine the time at which the command/address CMD/ADD are provided for a memory operation and/or a processing operation. In addition, the memory controller 120 may determine the location of the memory bank 131, the location of the activated row, and the location of an accessed column.

The PEs 133 may include varying numbers of PEs. For example, each PE may be arranged to correspond to one bank, or each PE may be arranged to correspond to two or more banks.

In addition, the location of the data Data to be used in the processing operation may be indicated in various manners. For example, as described above, information related to selecting a bank may be included in the address ADD accompanying the command CMD for the processing operation, or information of a bank in which the data Data to be used in an operation exists may be included in each of the instructions Inst. Alternatively, the PIM device 130 may be implemented so that the location of the data Data to be used in the processing operation may be indicated based on a combination of information stored in an instruction Inst and information stored in the address ADD.

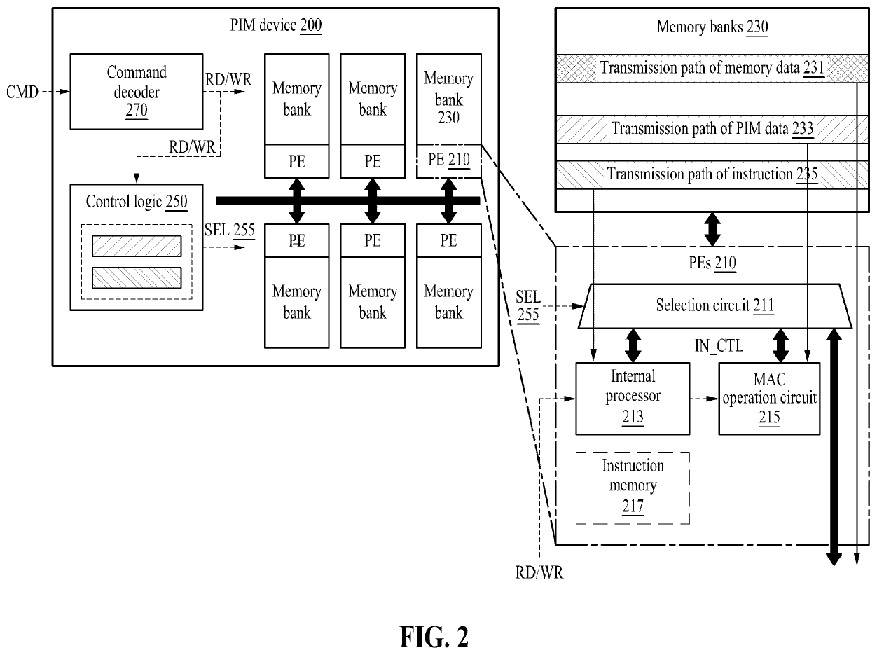

FIG. 2 is a diagram illustrating a configuration of a PIM device according to an embodiment. Referring to FIG. 2, a structure and operation in a configuration in which a single control logic 250 is included in a PIM device 200 is shown.

The PIM device 200 may include PEs 210, memory banks 230, the control logic 250 (e.g., a logic circuit), and a command decoder 270 (e.g., a decoder circuit). The PIM device 200 may perform a processing operation using at least one of data provided by a host device or data read from the memory banks 230. The PIM device 200 may process, for example, at least a portion of multiple operations for a neural network. In addition, the PIM device 200 may perform a processing operation using data received from the host device and weight information in the memory banks 230.

Each of the PEs 210 may include a selection circuit 211 that selects a path from among a transmission path 231 of memory data, a transmission path 233 of PIM data for a multiply-accumulate (MAC) operation, and a transmission path 235 of an instruction for an internal processor 213. Each of the PEs 210 may include at least one of the selection circuit 211, the internal processor 213, a MAC operation circuit 215 (e.g., a logic circuit), or an instruction memory 217. Here, the memory data may correspond to, for example, DRAM data. The transmission path 231 of memory data may be connected to a memory (e.g., DRAM) when, for example, a read/write operation of the DRAM is performed. The transmission path 233 of PIM data may correspond to a data path through which the MAC operation circuit 215 in the PEs 210 directly fetches operand data for a MAC operation from one or more of the memory banks 230. The transmission path 235 of an instruction may correspond to a data path directly connecting one or more of the memory banks 230 with the internal processor 213 for an instruction fetch. For example, the instruction may be fetched from one of the memory banks 230 and the fetched instruction may be transmitted along the transmission path 235 to the internal processor 213.

The selection circuit 211 may determine a path through which data of an activated row is to be fetched from each of the memory banks 230 according to a selection signal (SEL) 255 generated by the control logic 250. The selection circuit 211 may change the data path according to the selection signal (SEL) 255. For example, the selection circuit 211 may route data and instructions to different destinations according to the selection signal (SEL) 255.

The internal processor 213 may process instructions transmitted from the control logic 250.

The MAC operation circuit 215 may perform a MAC operation.

The instruction memory 217 may store an instruction for the internal processor 213. The instruction memory 217 may store at least one instruction provided by the host device. The instruction memory 217 may include a register that stores at least one of a memory command or an instruction for the internal processor 213 for reuse of the memory command or decoding of the instruction for the internal processor 213. The instruction memory 217 may also be referred to as an “instruction buffer” or an “instruction cache.”

An instruction stored in the instruction memory 217 may be directly loaded from the command decoder 270 by the internal processor 213 or may be used for processing such as reuse or decoding by the internal processor 213.

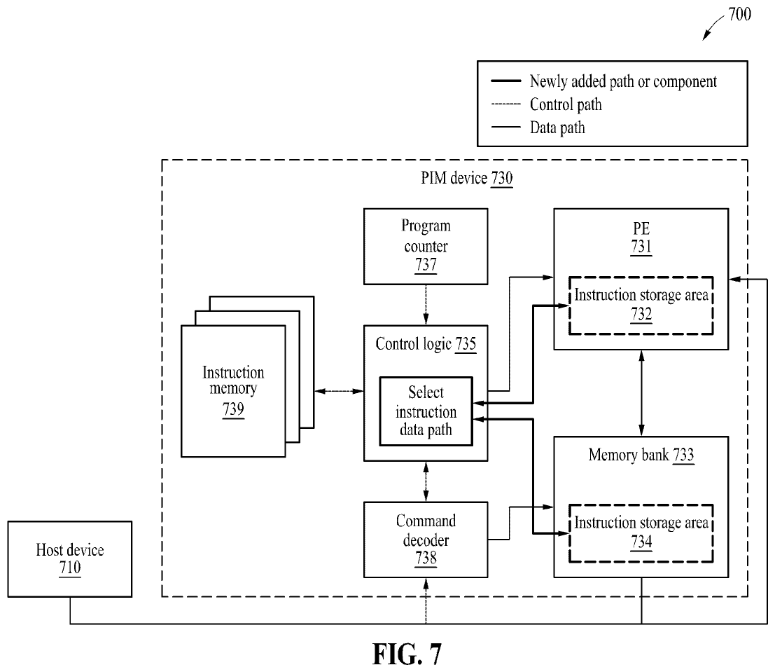

Each of the memory banks 230 may include memory cells. Each of the memory banks 230 may store data corresponding to each of the PEs 210. For each row of the memory banks 230, a storage area corresponding to the memory data, a storage area corresponding to the PIM data, and a storage area corresponding to the instruction for the internal processor 213 may be partitioned off from each other. Each of the memory banks 230 may store PIM binary (e.g., executable code) including at least one of a set of instructions or a plurality of memory commands, which are written by the host device and executed in the PIM device 200. An operation between the PIM device 200 and the host device is described in detail with reference to FIG. 7 below.

The control logic 250 may generate the selection signal (SEL) 255 that causes the selection circuit 211 to select the path in the memory banks 230. The control logic 250 may cause a same operation to be performed in all of the memory banks 230 using the single selection signal (SEL) 255.

The control logic 250 may use a row address corresponding to information stored in the memory banks 230, with which a storage area for the instruction and a storage area for the PIM data, both of which are in the memory banks 230, may be distinguished. The control logic 250 may divide the information stored in the memory banks 230 with the row address so that paths of the instruction, data (e.g., operand data for a MAC operation) for a PE, and the DRAM data (e.g., memory data for a normal memory operation) may be separated from each other. The control logic 250 may, using the selection signal (SEL) 255, cause each of the PEs 210 to select the data path and operate.

The control logic 250 may include a register configured to store row information of at least one of a PIM area for a PIM operation or a storage area of the memory data in each of the memory banks 230 according to the memory command. The register of the control logic 250 may store metadata (e.g., a row address) for distinguishing between instructions for the memory data (e.g., the DRAM data), the PIM data, and the internal processor 213.

The command decoder 270 may decode a memory command such as a read command RD or a write command WR for the memory banks 230 and the control logic 250. The command decoder 270 may decode an instruction and/or an address received from the host device.

In an embodiment, all of the PEs 210 in the PIM device 200 are set in the single control logic 250 and are used when, for example, a logic area of DRAM is greatly limited and/or a same operation is to be performed in multiple PEs by the single control logic 250.

In an embodiment, overflow of the instruction memory 217 may be prevented by storing an instruction set in the memory banks 230 in advance and fetching an instruction using a row address of a storage space of the instruction. In addition, overhead due to instruction writing by the host device may be reduced in performing of an operation by an operator.

In addition, in an embodiment, an entire area of memory banks may be used but a storage area for the instruction and a data storage area for the PEs 210 may be defined through the control logic 250, thereby allowing the PEs 210 to use the data storage area. The PIM device 200 may reduce overhead due to the instruction writing by configuring the instruction memory 217 to be in the PIM device 200.

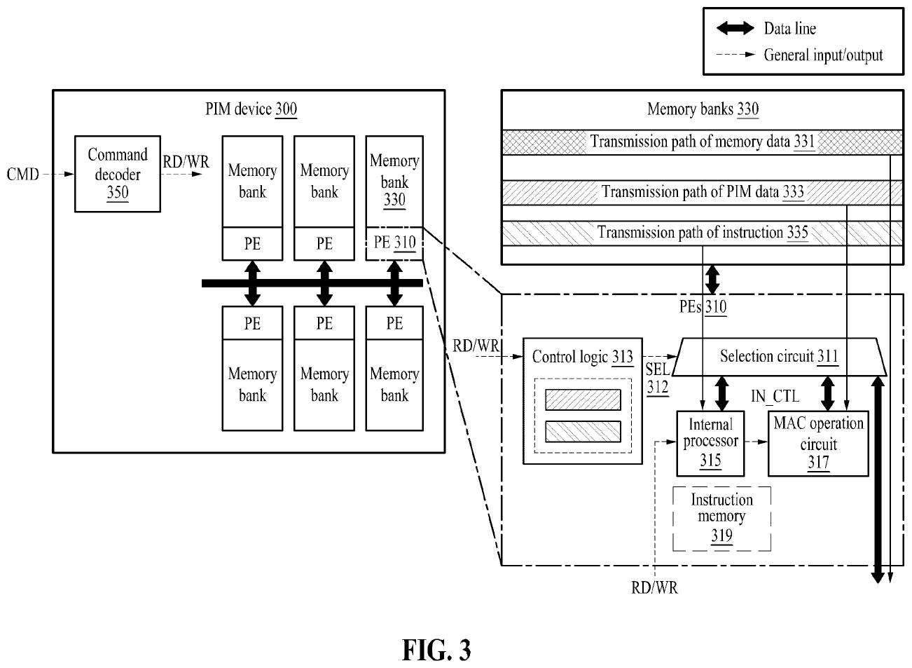

FIG. 3 is a diagram illustrating a configuration of a PIM device according to an embodiment. Referring to FIG. 3, a PIM device 300 may include PEs 310, memory banks 330, and a command decoder 350 (e.g., a decoder circuit). Hereinafter, the description focuses on an operation of the PIM device 300 that is different from the operation of the PIM device 200 of FIG. 2. With regard to other operation methods, the operation of the PIM device 200 of FIG. 2 may be referred to.

Each of the PEs 310 may include a selection circuit 311 and control logic 313 (e.g., a logic circuit). The selection circuit 311 may select a path from among a transmission path 331 of memory data, a transmission path 333 of PIM data for a MAC operation, and a transmission path 335 of an instruction for an internal processor 315. The selection circuit 311 may determine a path through which data of an activated row is to be fetched from a memory bank, among the memory banks 330, corresponding to the selection circuit 311 that received a selection signal (SEL) 312. The control logic 313 may generate the selection signal (SEL) 312 configured to cause the selection circuit 311 to select the path. The control logic 313 may include a register configured to store row information of at least one of a PIM area for a PIM operation or a storage area of the memory data in a memory bank, among the memory banks 330, corresponding to the control logic 313 that received the memory command.

Each of the PEs 310 may further include the internal processor 315, a MAC operation circuit 317 that performs a MAC operation, and an instruction memory 319 that stores an instruction for the internal processor 315. The instruction memory 319 may include a register that stores at least one of a memory command or an instruction for the internal processor 315 for reuse of the memory command or decoding of the instruction for the internal processor 315.

The memory banks 330 may store data corresponding to the PEs 310. Here, for each row of the memory banks 330, a storage area corresponding to the memory data, a storage area corresponding to the PIM data, and a storage area corresponding to the instruction for the internal processor 315 may be partitioned off from each other. Each of the memory banks 330 may store a PIM binary including at least one of a set of instructions or a plurality of memory commands, which are written by a host device and executed in the PIM device 300.

The command decoder 350 may decode a memory command such as a read command or a write command for the memory banks 330 and the control logic 313 included in each of the memory banks 330.

In an embodiment of the PIM device 300 all of the PEs 310 are set in the control logic 313 and are used, for example, when a logic area of DRAM is not greatly limited, when different operations are to be performed on each of the PEs 310 by the individual control logic 313, or when each of the PEs 310 is independently operating.

In FIG. 2 and FIG. 3, IN_CTL may correspond to a control line within the PE.

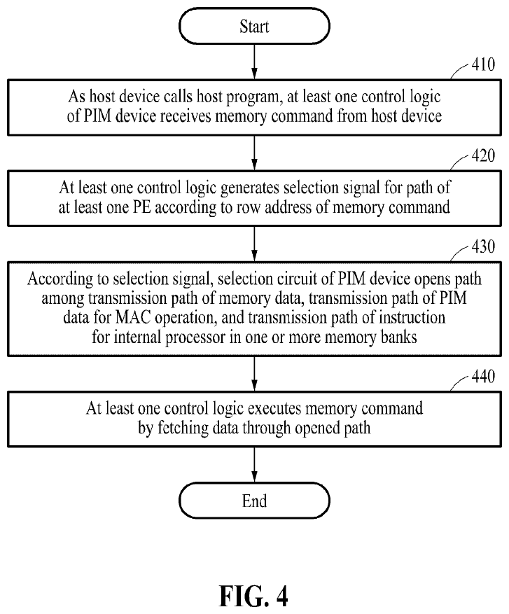

FIG. 4 is a flowchart illustrating an operating method of a PIM device, according to an embodiment. Operations to be described with reference to FIG. 4 and below may be sequentially performed, but are not limited thereto. For example, the order of the operations may change and at least two of the operations may be performed in parallel.

Referring to FIG. 4, a PIM device may execute a memory command through operations 410 to 440.

In operation 410, as a host device calls a host program, at least one control logic of the PIM device receives a memory command from the host device. For example, the host program executed by the host program may request that an operation be performed, and the host device may output the memory command to the control logic in response to the request. In this case, prior to receiving the memory command in operation 410, the host device may write a PIM binary in one or more memory banks of the PIM device. The PIM binary may include a plurality of memory commands and/or a set of instructions executed in the PIM device for an operation (e.g., a MAC operation or a convolution operation) of the PIM device. However, embodiments are not limited thereto. In addition, the host device may write row information of the one or more memory banks in the at least one control logic of the PIM device.

In operation 420, the at least one control logic of the PIM device generates a selection signal for a path of at least one PE according to a row address of a memory command. More specifically, the PIM device may transmit a data address of an operand for executing the memory command to a command decoder (e.g., 350) of the PIM device (e.g., 300). The command decoder may parse the memory command and transmit a row address of the memory command corresponding to the data address of the operand to the at least one control logic. The at least one control logic may generate the selection signal for the path of the at least one PE according to the row address of the received memory command. Here, for each row of the one or more memory banks, a storage area corresponding to memory data, a storage area corresponding to PIM data, and a storage area corresponding to an instruction for an internal processor may be partitioned off from each other.

In operation 430, according to the selection signal generated in operation 420, a selection circuit of the PIM device opens a path among a transmission path of memory data, a transmission path of PIM data for a MAC operation, and a transmission path of an instruction for an internal processor in the one or more memory banks. For example, as shown in FIG. 2, when the at least one control logic exists outside the at least one PE, the selection circuit may open the path in each of the one or more memory banks according to the selection signal. For example, opening the path may mean connecting or creating a path from one or more of the memory banks to another entity such as the instruction memory, the internal processor, or the mac operation circuit. In this case, a same operation may be performed on all of the one or more memory banks by one selection signal. Alternatively, when the at least one control logic exists in each of the at least one PE as shown in FIG. 3, the selection circuit may open the path in a memory bank, among the one or more memory banks, corresponding to a selection circuit that received the selection signal.

In operation 440, the at least one control logic executes the memory command received in operation 410 by fetching data through the path opened in operation 430.

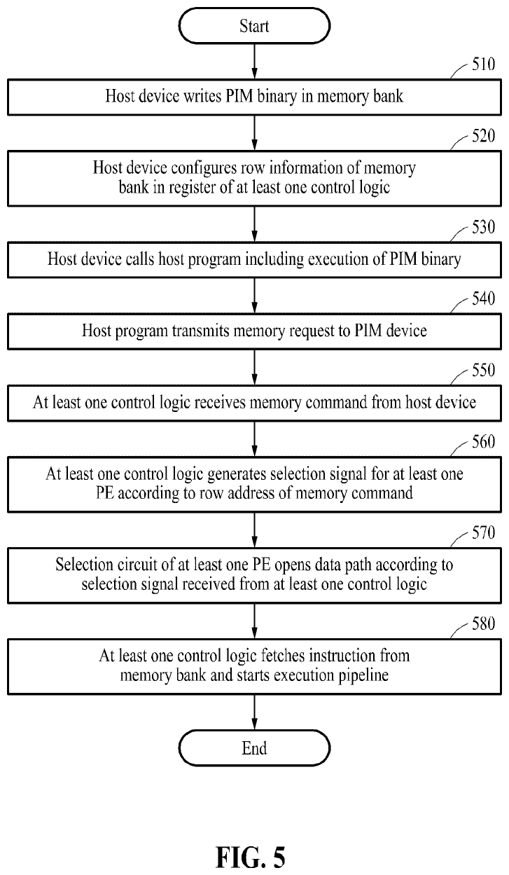

FIG. 5 is a flowchart illustrating a process of executing a memory command by selecting a data path between a host device and a PIM device, according to an embodiment. Referring to FIG. 5, a process in which the host device and the PIM device perform the memory command by fetching an instruction from a memory bank through operations 510 to 580 is shown.

In operation 510, the host device writes a PIM binary in a memory bank of the PIM device. Here, the PIM device may be, for example, the PIM device 200 described above with reference to FIG. 2 or the PIM device 300 described above with reference to FIG. 3. However, embodiments are not limited thereto.

In operation 520, the host device configures or stores row information of the memory bank in a register of at least one control logic of the PIM device. Here, a single control logic may be present in the PIM device as shown in FIG. 2, or a control logic may be present in each PE as shown in FIG. 3.

In operation 530, the host device calls (or runs) a host program including an execution of the PIM binary. For example, the PIM binary may be an instruction or executable code that is executed by the host program.

In operation 540, the host program may a memory request to the PIM device. For example, executing the PIM binary may result in generation of the memory request since the host program may need the results of an operation.

In operation 550, the at least one control logic of the PIM device receives the memory command from the host device.

In operation 560, the at least one control logic of the PIM device generates a selection signal for at least one PE according to a row address of the memory command.

In operation 570, a selection circuit of the at least one PE opens a data path according to the selection signal received from the at least one control logic.

In operation 580, the at least one control logic of the PIM device executes the memory command by fetching an instruction from the memory bank and starting an execution pipeline. For example, the instruction may be fetched through the data path.

The PIM device may select one storage space between a storage space of the instruction memory and a storage space of the PIM binary in a memory bank area through the selection circuit and set a data path through which to fetch an instruction from the selected storage space to fetch the instruction.

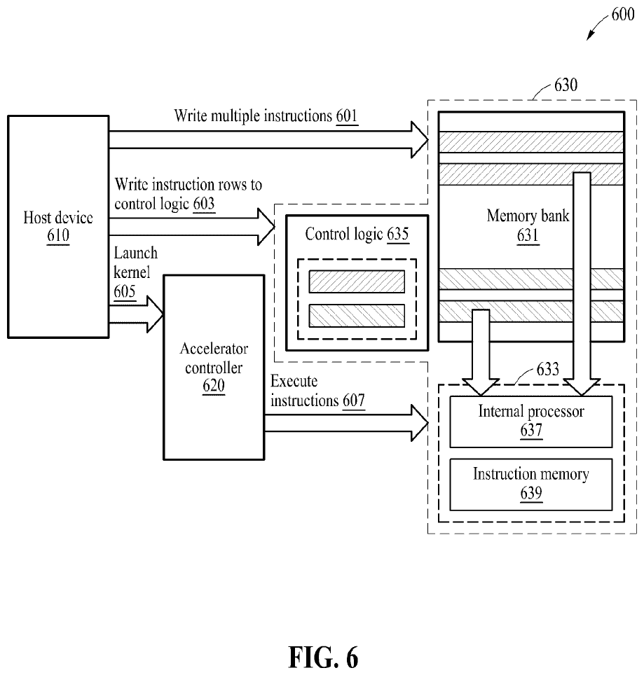

FIG. 6 is a diagram illustrating an operating method of an instruction of a PIM device, according to an embodiment. Referring to FIG. 6, a diagram 600 is shown illustrating an operating method between a host device 610 and a PIM device 630 in a case of an operation request through a host program.

In operation 601, the host device 610 writes multiple instructions to an instruction memory 639 of the PIM device 630. The multiple instructions may include an instruction block or a PIM binary consisting of a plurality of memory commands and a set of instructions for a PIM operation in the host program.

In operation 603, the host device 610 writes row information indicating that an area in a memory bank 631 is an instruction area in which information corresponding to a specific instruction is stored. The row information may be written to the control logic 635. By doing the above, the PIM device 630 may directly fetch the instruction through the row information to improve an execution time of the execution pipeline, thereby reducing overhead due to data movement during an operation.

Subsequently, when an operation request occurs, the host device 610 may, for example, launch a kernel (e.g., the host program) on an accelerator controller 620 in operation 605.

In operation 607, the accelerator controller 620 performs an operation by executing instructions using the PIM device 630. Here, a control logic 635 of the PIM device 630 may fetch and execute instructions written in the instruction memory 639. A data address of an operand of the instructions may be transmitted to the control logic 635 through a memory command transmitted from the host device 610. The memory command transmitted to the control logic 635 may be parsed by a command decoder of the PIM device 630. Memory address information (e.g., column information and/or row information) of an operand obtained through parsing may be transmitted to the control logic 635.

Here, the memory command need not only transmit operand information but may also operate as a program counter to control a location of an instruction to be executed on the instruction memory 639.

A PIM instruction transmitted through the memory command may include, for example, an operation (OP) code, a first operand, a second operand, and a third operand. The OP code may correspond to a code indicating an operation to be performed in a PE within the PIM device 630. The OP code may include an arithmetic operation such as addition and subtraction and/or a data movement operation for moving data between the memory bank 631 and a register.

Each operand may specify a location of operation data needed for input, output, and other operations, and each operand may include an index of a register in the PE (e.g., a general register file (GRF) and a general-purpose register) or a row address and a column address of the memory bank 631. When the operand is in the memory bank 631, the PIM device 630 may obtain a location of a performed operand by interpreting the address of the operand using the row address and column address received from the memory command.

When performing a PIM operation within the PIM device 630, the PIM device 630 may use the transmitted memory command as a program counter as well as for transmitting information on the operand. Here, the memory command may increase the program counter of an internal processor. For example, when four read commands RD memory commands are delivered and stored in an instruction buffer or an instruction memory, the PIM device 630 may increase the program counter by one from 0 to 3 each time a read command RD is transmitted.

In this case, the PIM device 630 may identify an area of a PIM binary using metadata information such as a row address stored in a register in the control logic 635. Accordingly, the PIM device 630 may pre-load multiple PIM binaries, store the multiple PIM binaries in an area of the memory bank 631, and subsequently store metadata information (e.g., a type of operation, a size of operation or hardware information) on the stored PIM binaries as row information in the control logic 635.

Thereafter, during an execution of an instruction, an internal processor 637 may process instruction(s) transmitted from the control logic 635. When the instruction(s) transmitted from the control logic 635 are reused afterwards, the PIM device 630 may perform optimization in which the instructions are separately stored and/or managed in the instruction memory 639.

The memory bank 631 may be entirely used as a buffer to store an instruction, thereby facilitating reuse of the instruction. In addition, in an embodiment, the memory bank 631 is used without being partitioned into a PIM area and a memory bank area, in which case all sets of instructions that need to be executed may be stored in the memory bank 631 and the internal processor 637 may directly fetch an instruction from the memory bank 631 by using row information.

FIG. 7 is a diagram illustrating an operation between a host device and a PIM device, according to an embodiment. Referring to FIG. 7, a diagram 700 is shown illustrating a configuration and operation of a PIM device having an instruction storage area in a memory bank.

When a host device 710 transmits instruction(s) corresponding to storage areas, control logic 735 (e.g., logic circuit) of a PIM device 730 may fetch an instruction stored in the storage areas and perform the fetched instruction. In this case, overhead due to instruction writing may be minimized as a plurality of instruction memories 739 may be provided in the PIM device 730.

The PIM device 730 may be located in various memory devices including DRAM described above.

The PIM device 730 may include one or more instruction memories 739.

Instruction storage areas (e.g., an instruction storage area 732 of a PE 731 and an instruction storage area 734 of a memory bank 733) may be allocated to the PE 731 and the memory bank 733 of the PIM device 730, respectively. Here, to perform an instruction fetch, a data path connecting the instruction storage area 732 of the PE 731, the instruction storage area 734 of the memory bank 733, and the instruction memory 739 may be provided. The control logic 735 may determine or create a data path for the instruction fetch.

When an operation request occurs through an application program interface (API) in the host device 710, the host device 710 may write a PIM binary, which is a set of instructions corresponding to the API, in the instruction memory 739. The control logic 735 may fetch and perform instructions (e.g., a memory command) written in the instruction memory 739.

Instructions (e.g., a memory command) transmitted to the control logic 735 may be parsed by a command decoder 738, and memory address information of an operand obtained through the parsing may be transmitted to the control logic 735. Here, the transmitted memory command need not only transmit operand information as described above but may also operate as a program counter 737 to control a location of an instruction to be executed in the instruction memory 739. For example, when the PIM device 730 includes the plurality of instruction memories 739 as shown in FIG. 7, the operation may be as follows.

The host device 710 may store a PIM binary or an instruction block corresponding to an operator selectively in one or more among the plurality of instruction memories 739, the instruction storage area 732 of the PE 731, and the instruction storage area 734 of the memory bank 733. For example, when a given operator is frequently used (e.g., used more than a threshold number of times in a given period) and the sizes of instructions are not large (i.e., less than a certain size), the host device 710 may store the PIM binary corresponding to the operator in the plurality of instruction memories 739. Alternatively, when an operator is used less frequently (e.g., used less than a threshold number of times in a given period) but used for purposes such as debugging, or in the case of a PIM binary having a size unfit for the instruction memory 739, the host device 710 may store the PIM binary corresponding to the operator in the instruction storage area 732 of the PE 731 or the instruction storage area 734 of the memory bank 733 so that the control logic 735 may directly fetch an instruction through a data path. In this case, the instruction storage area 732 of the PE 731 or the instruction storage area 734 of the memory bank 733 may be directly connected to a determined row buffer in the memory bank 733. However, embodiments are not limited thereto.

Alternatively, for example, when the host device 710 writes one or more PIM binaries into the plurality of instruction memories 739 and transmits the location of the PIM binaries using a register in the control logic 735 or a memory command, a selection circuit of the control logic 735 may set a data path for an instruction so that instruction fetch may be performed as controlled by the host device 710.

Similarly, when the control logic 735 selects the instruction memory 739, a data path may be selected using information (e.g., metadata information) transmitted through the register or memory command.

Although it is described above that a data path may be selected by the selection circuit in the control logic 735, the host device 710 may select a data path and the metadata information may be transmitted to the PIM device 730 to execute the instruction.

When the plurality of instruction memories 739 are used, the number of operators may be fixed, and the PIM device 730 may repeatedly reuse a PIM binary without an eviction policy in the form of execution that is repeatedly performed.

In addition, by supporting the instruction storage area 732 of the PE 731 and the instruction storage area 734 of the memory bank 733, it may be possible to support an operation of a PIM binary that cannot be performed due to a size limit of the instruction memory 739. Furthermore, by providing various PIM binaries, usability in various fields such as debugging may be increased.

Alternatively, the instruction memory 739 may be variably set. When a plurality of sections is variably set in the instruction memory 739 through methods such as dividing the instruction memory 739 into a plurality of sections or providing a physically separate register file, a PIM binary may be designated and managed by the host device 710.

In addition, the process of selecting a data path for an instruction, which may be performed by the control logic 735, may also be performed by the host device 710. When the host device 710 performs the process of selecting a data path for an instruction, the host device 710 may identify an appropriate location of a corresponding PIM binary through results such as a compiler and transmit information (e.g., metadata information) on the location to the PIM device 730.

By supporting variable PIM binaries through the instruction memory 739 that is variably set, the instruction memory 739 may be efficiently managed. In addition, by supporting all PIM binaries needed for an application, overhead due to replacement of the PIM binaries may be reduced. When the host device 710 performs the process of selecting a data path for an instruction, a decrease in the capacity of the PIM device 730 or a memory device may be prevented and an interface between an operation processing operation and a memory operation may be minimized by maintaining only a register for the minimum information.

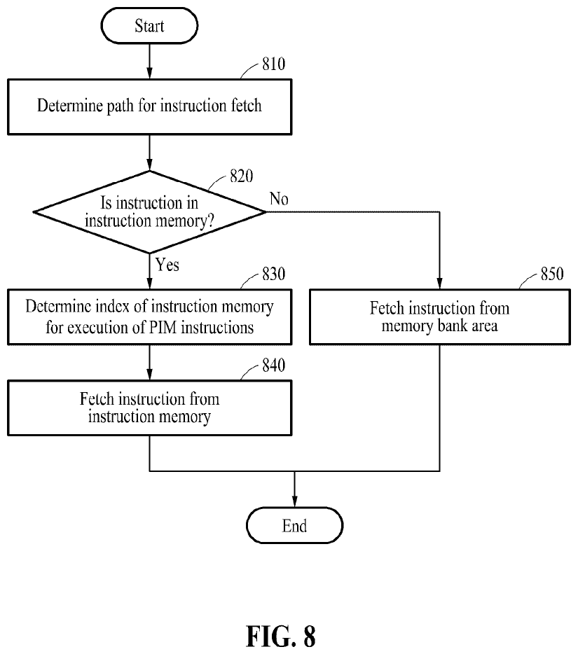

FIG. 8 is a flowchart illustrating a method of selecting a data path, according to an embodiment. Referring to FIG. 8, a PIM device may fetch an instruction through a data path selected through operations 810 to 870.

In operation 810, the PIM device determines a path (e.g., the data path) for a instruction fetch. The PIM device may determine whether the path determined for instruction fetch in operation 810 is to an instruction memory or a memory bank area.

In operation 820, the PIM device determines whether the instruction is present in the instruction memory. For example, the PIM device may determine whether an area reachable by the determined path includes the instruction. When it is determined in operation 820 that the instruction is present in the instruction memory (e.g., the instruction memory 739 of FIG. 7), the PIM device determines an index of the instruction memory for execution of PIM instructions in operation 830. Here, the PIM instructions may correspond to instructions executed for a processing operation and/or a memory operation in the PIM device.

In operation 840, the PIM device fetches the instruction from the instruction memory using the memory index determined in operation 830.

When it is determined in operation 820 that the instruction is not present in the instruction memory, the PIM device fetches the instruction from the memory bank area in operation 850.

In an embodiment, an instruction fetch may be performed after a storage space of a PIM binary in a memory bank area and an instruction memory is selected by a selection circuit of the PIM device and a data path for fetching an instruction from the selected storage space is set so that the instruction may be stored in a cache memory and thus the instruction fetch may be performed smoothly without using a reuse process.

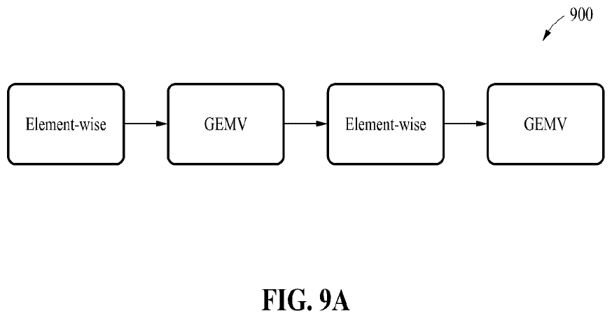

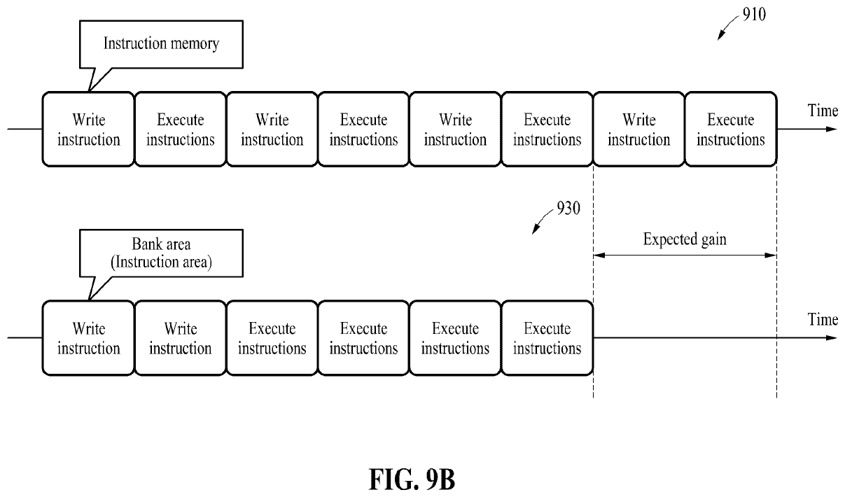

FIG. 9A is a diagram illustrating a structure in which an element-wise operation and a GEMV operation are repeated in a neural network. Referring to FIG. 9A, a diagram 900 is shown illustrating a structure in which an element-wise operation and a GEMV operation are repeatedly performed in a neural network.

When a neural network repeatedly performs, for example, operations on two PIM binaries, as shown in the diagram 900, processing efficiency may be significantly reduced since an instruction may only be executed after the PIM binary is written in an instruction memory.

FIG. 9B is a diagram illustrating results of an instruction writing operation and an instruction execution operation compared between a general PIM device and a PIM device according to an embodiment. Referring to FIG. 9B, a diagram 910 illustrating an instruction writing operation and an instruction execution operation in a general PIM device and a diagram 930 illustrating an instruction writing operation and an instruction execution operation in a PIM device according to an embodiment are shown.

Due to the operating characteristics of a PIM device, when a greater number of pieces of operand data are used for one operator, processing efficiency may be increased compared to the case in which an operation logic connected to an external interface is used.

For example, when multiple instruction memories are used, in the case of an application that has a toggling operation pattern (e.g., when a PIM binary #0 and a PIM binary #1 are repeatedly performed) when using a single instruction memory, performance degradation may occur since a host device may need to perform a writing operation for the replacement of the PIM binary each time the PIM binary is replaced.

In particular, since deep learning applications mainly have a structure in which an operation with a specific pattern is repeatedly performed, using an appropriate number of instruction memories may contribute to the performance of the PIM device.

The PIM device according to an embodiment may store all sets of instructions that need to be executed in a memory bank as shown in the diagram 930 and may allow execution of the instructions through accessing a data path using row information, thereby reducing writing overhead of updating instructions in an instruction memory before executing the instructions as shown in the diagram 910 for overcoming a size limit of the instruction memory.

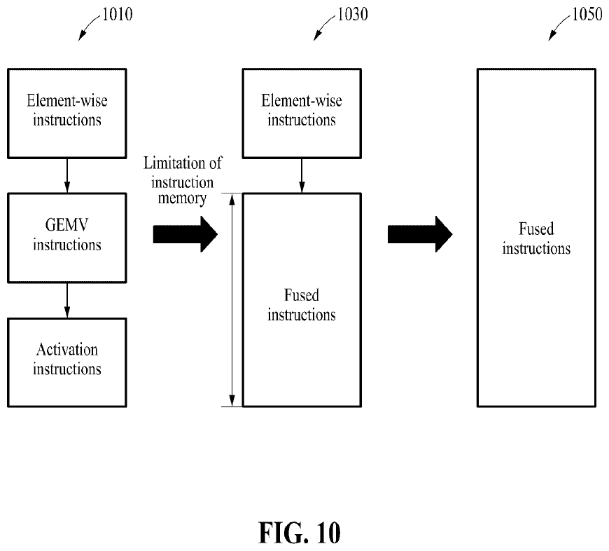

FIG. 10 is a diagram illustrating a method of resolving constraints due to limitations of instruction memory in a PIM device, according to an embodiment. Referring to FIG. 10, a diagram 1030 illustrating a case in which there is a size limit to an instruction memory and a diagram 1050 illustrating a case in which there is no size limit to an instruction memory are shown. Both may be a case when an instruction set 1010, which is a set of instructions executed in the PIM device, is fused.

The PIM device may configure the instruction set 1010 to include fused instructions, using a memory bank. Here, when there is a limit to the size of the instruction memory, the PIM device may configure fused instructions by fusing instructions for a GEMV operation with instructions for activation and excluding instructions for an element-wise operation.

On the contrary, when there is no limit to the size of the instruction memory, the PIM device may configure fused instructions by fusing the instructions for an element-wise operation, the instructions for a GEMV operation, and the instructions for activation, as shown in a diagram 1050.

The PIM device may store all instruction sets that need to be executed in a memory bank and may allow execution of the instructions through accessing a data path using row information so that the instruction memory may be used for various purposes, such as debugging, without limiting a size of the instruction memory.

The PIM device may perform instructions that may be offloaded by fusing the instructions as much as possible. In addition, the PIM device may freely execute commands for debugging purposes to check the operation of the PIM device.

The embodiments described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular. However, one of ordinary skill in the art will appreciate that a processing device may include multiple PEs and/or multiple types of PEs. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described examples. The media may also include the program instructions, data files, data structures, and the like alone or in combination. The program instructions recorded on the media may be those specially designed and constructed for the embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), random-access memory (RAM), flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described embodiments, or vice versa.

Although the embodiments have been described with reference to certain drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A processing-in-memory (PIM) device comprising:
processing elements (PEs), wherein each of the PEs comprises a selection circuit configured to select a path from among a transmission path of memory data, a transmission path of PIM data for a multiply-accumulate (MAC) operation, and a transmission path of an instruction for an internal processor;
memory banks configured to store data corresponding to the PEs;
a control logic configured to generate a selection signal configured to cause the selection circuit to select the path to a memory bank among the memory banks; and
a command decoder configured to decode a memory command for the memory bank and the control logic.

2. The PIM device of claim 1, wherein the selection circuit is configured to:
determine the path through which data of an activated row is to be fetched from each of the memory banks according to the selection signal.

3. The PIM device of claim 1, wherein, for each row of each of the memory banks, a storage area corresponding to the memory data, a storage area corresponding to the PIM data, and a storage area corresponding to the instruction for the internal processor are partitioned off from each other.

4. The PIM device of claim 1, wherein the control logic comprises:
a register configured to store row information of at least one of a PIM area for a PIM operation or a storage area of the memory data in each of the memory banks according to the memory command.

5. The PIM device of claim 1, wherein each of the PEs comprises at least one of:
the internal processor;
a MAC operation circuit configured to perform the MAC operation; or
an instruction memory configured to store the instruction for the internal processor.

6. The PIM device of claim 5, wherein the instruction memory comprises:
a register configured to store at least one of the memory command or the instruction for the internal processor, for reuse of the memory command or decoding of the instruction for the internal processor.

7. The PIM device of claim 1, wherein each of the memory banks is configured to store a PIM binary comprising at least one of a set of instructions or a plurality of memory commands, which are written by a host device and executed in the PIM device.

8. A processing-in-memory (PIM) device comprising:
processing elements (PEs);
memory banks configured to store data corresponding to the PEs; and
a command decoder configured to decode a memory command for a memory bank among the memory banks,
wherein each of the PEs comprises:
a selection circuit configured to select a path from among a transmission path of memory data, a transmission path of PIM data for a multiply-accumulate (MAC) operation, and a transmission path of an instruction for an internal processor; and
control logic configured to generate a selection signal configured to cause the selection circuit to select the path to the memory bank.

9. The PIM device of claim 8, wherein the selection circuit is configured to:
determine the path through which data of an activated row is to be fetched from the memory bank, in response to the selection signal.

10. The PIM device of claim 8, wherein, for each row of each of the memory banks, a storage area corresponding to the memory data, a storage area corresponding to the PIM data, and a storage area corresponding to the instruction for the internal processor are partitioned off from each other.

11. The PIM device of claim 8, wherein the control logic comprises:
a register configured to store row information of at least one of a PIM area for a PIM operation or a storage area of the memory data in the memory bank, in response to the memory command.

12. The PIM device of claim 8, wherein each of the PEs comprises:
the internal processor;
a MAC operation circuit configured to perform the MAC operation; or
an instruction memory configured to store the instruction for the internal processor.

13. The PIM device of claim 12, wherein the instruction memory comprises:
a register configured to store at least one of the memory command or the instruction for the internal processor, for reuse of the memory command or decoding of the instruction for the internal processor.

14. The PIM device of claim 8, wherein each of the memory banks is configured to store a PIM binary comprising at least one of a set of instructions or a plurality of memory commands, which are written by a host device and executed in the PIM device.

15. An operating method of a processing-in-memory (PIM) device, the method comprising:
receiving, by control logic of the PIM device, a memory command from a host device when the host device executes a host program;
generating, by the control logic, a selection signal for a path to at least one processing element (PE) according to a row address of the memory command;
opening, by a selection circuit of the PIM device, the path among a transmission path of memory data, a transmission path of PIM data for a multiply-accumulate (MAC) operation, and a transmission path of an instruction for an internal processor to a memory bank among a plurality memory banks according to the selection signal; and
executing, by the control logic, the memory command by fetching data through the opened path.

16. The method of claim 15, wherein the generating of the selection signal for the path to the at least one PE comprises:
transmitting a data address of an operand for executing the memory command to a command decoder; and
transmitting, by the command decoder, the row address of the memory command corresponding to the data address of the operand to the control logic by parsing the memory command.

17. The method of claim 15, wherein, when the control logic is present outside the at least one PE, the opening of the path comprises:
opening, by the selection circuit, the path in each of the memory banks according to the selection signal.

18. The method of claim 15, wherein, when the control logic is present in each of the at least one PE, the opening of the path comprises:
opening, by the selection circuit, the path in the memory bank, in response to receiving the selection signal.

19. The method of claim 15, wherein, for each row of the memory banks, a storage area corresponding to the memory data, a storage area corresponding to the PIM data, and a storage area corresponding to the instruction for the internal processor are partitioned off from each other.

20. The method of claim 15, further comprising:
writing, by the host device, a PIM binary into the memory bank of the PIM device; and
writing, by the host device, row information of the memory bank into the control logic of the PIM device.

21. A processing-in-memory (PIM) device comprising:
a memory bank comprising a first region for storing memory data, a second region for storing PIM data, and a third region storing an instruction;
an internal processor;
a logic circuit configured to perform a multiply-accumulate (MAC) operation; and
a selection circuit connecting one of i) the first region to a first path to enable a host device to access the memory data, ii) the second region to a second path to enable the logic circuit to perform the MAC operation on the PIM data, and iii) the third region to a third path to enable the internal processor to execute the instruction, in response to receipt of a selection signal.

22. The PIM device of claim 21, further comprising control logic that generates the selection signal in response to receipt of a read command or a write command.
